(19) United States
(12) Patent Application Publication
(10) Pub. No.: US 2026/0204257 A1
(43) Pub. Date: Jul. 16, 2026

(54) INTERACTIVE ROBOT, CONTROL METHOD, AND NON-TRNSITORY COMPUTER READABLE RECORDING MEDIUM

(71) Applicant: PANASONIC INTELLECTUAL PROPERTY MANAGEMENT CO., LTD., Osaka (JP)

(72) Inventor: Tomomi Matsuoka, Osaka (JP)

(21) Appl. No.: 19/442,269

(22) Filed: Jan. 7, 2026

Related U.S. Application Data
(63) Continuation of application No. PCT/JP2024/022718, filed on Jun. 24, 2024.

(30) Foreign Application Priority Data
Jul. 13, 2023 (JP) 2023-115481

(51) Int. Cl. G10L 15/22; G10L 13/02; G10L 25/78; H04R 1/32

(52) U.S. Cl. CPC G10L 15/22; G10L 13/02; G10L 25/78; H04R 1/326

(57) ABSTRACT

A dialogue robot acquires a voice signal indicative of a voice of a user collected by a microphone part, estimates a direction toward the user on the basis of the voice signal, outputs to an actuator an action signal of causing the dialogue robot to perform a response action of aligning a directivity direction of the microphone part with the estimated direction toward the user, and causes a speaker to continuously output a response sound to the user while the response action is performed.

### FIELD OF INVENTION

The present disclosure relates to a dialogue robot which talks with a user.

### BACKGROUND ART

Patent Literature 1 discloses the following technique to make an action of a robot appear to be natural. Specifically, Patent Literature 1 discloses a technique including estimating a direction toward a sound source on the basis of an input signal of sound received by a microphone array, controlling one or both of a line of vision and a posture of the robot to make an attention direction of the robot coincide with the estimated direction toward the sound source, and aligning a directivity direction of the microphone array with the attention direction.

However, the technique of Patent Literature 1 involves the following problem. When a user talks to the robot during the controlling of the line of vision, the posture, or others of the robot to make the attention direction of the robot coincide with the direction toward the sound source, the robot is liable to misrecognize the voice of the user since the directivity direction of the microphone array does not still align with a direction toward the user.

Patent Literature 1: Japanese Patent No. 3771812

### SUMMARY OF THE INVENTION

The present disclosure has been made in order to solve the problems described above, and an object thereof is to provide a technique for preventing a dialogue robot from misrecognizing a voice of a user while performing a response action.

A dialogue robot according to an aspect of the present disclosure includes a microphone part that includes a plurality of microphones, an actuator that actuates the dialogue robot, a speaker, and a processor, wherein the processor acquires a voice signal indicative of a voice of a user collected by the microphone part, estimates a direction toward the user on the basis of the voice signal, outputs to the actuator an action signal of causing the dialogue robot to perform a response action of aligning a directivity direction of the microphone part with the estimated direction toward the user, and causes the speaker to continuously output a response sound to the user while the response action is performed.

The present disclosure can prevent a dialogue robot from misrecognizing a voice of a user while performing a response action.

### BRIEF DESCRIPTION OF THE DRAWINGS

FIG. 1 is a front view of an exterior of a dialogue robot according to an embodiment.

FIG. 2 is a diagram showing an exemplary rotating mechanism of the dialogue robot.

FIG. 3 is a block diagram showing an exemplary configuration of the dialogue robot.

FIG. 4 is a diagram showing a positional relationship between the dialogue robot and a user.

FIG. 5 is a flowchart showing an exemplary process of a dialogue robot according to Embodiment 1.

FIG. 6 is a flowchart showing an exemplary process of a dialogue robot according to Embodiment 2.

FIG. 7 is a block diagram showing an exemplary configuration of a dialogue robot according to Embodiment 3.

FIG. 8 is a flowchart showing an exemplary process of the dialogue robot according to Embodiment 3.

FIG. 9 is a block diagram showing an exemplary configuration of a dialogue robot according to Embodiment 4.

FIG. 10 shows an exemplary data structure of a response duration table.

FIG. 11 is a flowchart showing an exemplary process of the dialogue robot according Embodiment 4.

FIG. 12 is a block diagram showing an exemplary configuration of a dialogue robot system according to Embodiment 5.

### DETAILED DESCRIPTION

### Knowledge Underlying the Present Disclosure

Researches on dialogue robots that talk with users are underway. Studies are herein carried out on causing a dialogue robot to output from a speaker a response sound such as “Yes” in response to a call by a user and perform a response action of rotating in a direction toward the user to align a directivity direction of a microphone part provided in the dialogue robot with the direction toward the user.

For example, if a dialogue robot outputs a response sound only at a start time of a rotating action, a user will be puzzled whether to be permitted to talk to the dialogue robot or not because the dialogue robot is rotating. This is likely to lead to a situation where the user talks to the dialogue robot during the rotation of the dialogue robot. In this situation, the dialogue robot is liable to misrecognize the voice of the user since the directivity direction of the microphone part does not still align with the direction toward the user.

Patent Literature 1 does not take into consideration a situation that a user talks to the robot while the robot is performing an action of controlling the line of vision and the posture thereof to make the attention direction coincide with the direction toward the sound source, thus the user cannot clearly determine whether to be permitted to talk to the robot or not during this action. In Patent Literature 1, accordingly, the situation is likely to happen that the user talks to the robot during the rotating action. In this situation, the robot is liable to misrecognize the voice of the user since the directivity direction of the microphone part does not still align with the direction toward the sound source.

The present inventors have obtained the knowledge that a continuous output of a response sound from a speaker during a response action keeps a user from uttering during the response action, which makes it possible to prevent a misrecognition of a voice during the response action, and worked out the present disclosure.

(1) A dialogue robot according to an aspect of the present disclosure includes a microphone part that includes a plurality of microphones, an actuator that actuates the dialogue robot, a speaker, and a processor, wherein the processor acquires a voice signal indicative of a voice of a user collected by the microphone part, estimates a direction toward the user on the basis of the voice signal, outputs to the actuator an action signal of causing the dialogue robot to perform a response action of aligning a directivity direction of the microphone part with the estimated direction toward the user, and causes the speaker to continuously output a response sound to the user while the response action is performed.

In this configuration, the response sound to the user is continuously output from the speaker while the response action of aligning the directivity direction of the microphone part with the estimated direction toward the user is performed by the dialogue robot. This can keep the user from uttering during the response action and thus prevent misrecognition of the voice during the response action.

(2) In the dialogue robot recited in the above-mentioned (1), it may be appreciated that the processor calculates an angle between the directivity direction of the microphone part and the direction toward the user on the basis of the voice signal, determines a response duration indicative of a duration of the response action on the basis of the angle, and causes the speaker to continuously output the response sound during the response duration.

In this configuration, the response duration is determined on the basis of the angle between the directivity direction of the microphone part and the direction toward the user. Thus, an end time of the output of the response sound can be determined without monitoring the response action to detect the end time of the output of the response sound.

(3) In the dialogue robot recited in the above-mentioned (1) or (2), it may be appreciated that the processor acquires an action speed of the dialogue robot in the response action, calculates a response duration indicative of a duration of the response action on the basis of the action speed, and causes the speaker to continuously output the response sound during the response duration.

In this configuration, the response duration is calculated by taking into account the action speed of the dialogue robot. Thus, the end time of the output of the response sound can be made to exactly coincide with the end time of the response action.

(4) The dialogue robot recited in any one of the above-mentioned (1) to (3) may be appreciated to further include a memory that stores response duration information concerning the angle between the directivity direction and the direction toward the user and the response duration indicative of the duration of the response action corresponding to the angle, wherein the processor refers to the response duration information and determines the response duration corresponding to the calculated angle.

In this configuration, the response duration information is referred to. Thus, the response duration corresponding to the angle can be easily determined.

(5) In the dialogue robot recited in any one of the above-mentioned (1) to (4), it may be appreciated that the response action includes an action of rotating the dialogue robot to align the directivity direction of the microphone part with the estimated direction toward the user.

In this configuration, the directivity direction of the microphone part can be aligned with the direction toward the user merely by rotating the dialogue robot.

(6) In the dialogue robot recited in any one of the above-mentioned (1) to (5), it may be appreciated that the action speed includes a rotational speed of the dialogue robot, and the response duration is calculated by dividing the angle between the directivity direction of the microphone part and the estimated direction toward the user by the rotational speed.

In this configuration, the response duration can be accurately calculated.

(7) In the dialogue robot recited in any one of the above-mentioned (1) to (6), the directivity direction may include a forward direction of the dialogue robot.

In this configuration, the forward direction of the dialogue robot is aligned with the direction toward the user in accordance with the response action. Thus, a time when the user is permitted to talk to the dialogue robot can be explicitly shown to the user.

(8) A control method according to another aspect of the present disclosure is a control method for a dialogue robot by a computer, and includes acquiring a voice signal indicative of a voice of a user collected by a microphone part that is provided in the dialogue robot and includes a plurality of microphones, estimating a direction toward the user on the basis of the voice signal, outputting to an actuator of the dialogue robot an action signal of causing the dialogue robot to perform a response action of aligning a directivity direction of the microphone part with the estimated direction toward the user, and causing a speaker of the dialogue robot to continuously output a response sound to the user while the response action is performed.

This configuration makes it possible to provide a control method for the dialogue robot that can prevent a misrecognition of the voice of the user during the response action.

(9) A program according to still another aspect of the present disclosure is a program for causing a computer to execute a control method for a dialogue robot, the program causing the computer to: acquire a voice signal indicative of a voice of a user collected by a microphone part that is provided in the dialogue robot and includes a plurality of microphones, estimate a direction toward the user on the basis of the voice signal, output to an actuator of the dialogue robot an action signal of causing the dialogue robot to perform a response action of aligning a directivity direction of the microphone part with the estimated direction toward the user, and cause a speaker of the dialogue robot to continuously output a response sound to the user while the response action is performed.

This configuration makes it possible to provide a program that can prevent the misrecognition of the voice of the user during the response action.

The present disclosure may also accomplish a dialogue robot system which operates in accordance with the computer program. It is needless to say that the computer program may be transferred via a computer-readable non-transitory recording medium such as a CD-ROM or a communication network such as Internet.

Each of embodiments described below shows a specific example of the present disclosure. Numerical values, shapes, elements, steps, order of steps, and the like that are indicated in the following embodiments are merely examples, and are not intended to delimit the present disclosure. Among the elements in the following embodiments, elements not recited in the independent claims representing the broadest concepts are described as optional elements. In all the embodiments, the respective contents may also be combined.

### Embodiment 1

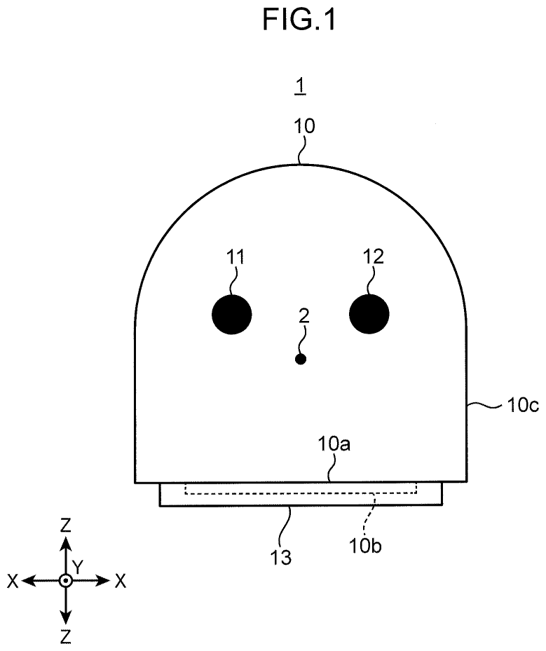

FIG. 1 is a front view of an exterior of a dialogue robot 1 according to Embodiment 1. In FIG. 1, a Y direction is a forward direction of the dialogue robot 1, X directions are directions to the left and to the right of the dialogue robot 1, and Z directions are upward and downward directions of the dialogue robot 1. The dialogue robot 1 includes a main body 10, cameras 11, 12, and a base 13. The main body 10 is rotatable relative to the base 13 about a Z axis or in a yaw direction.

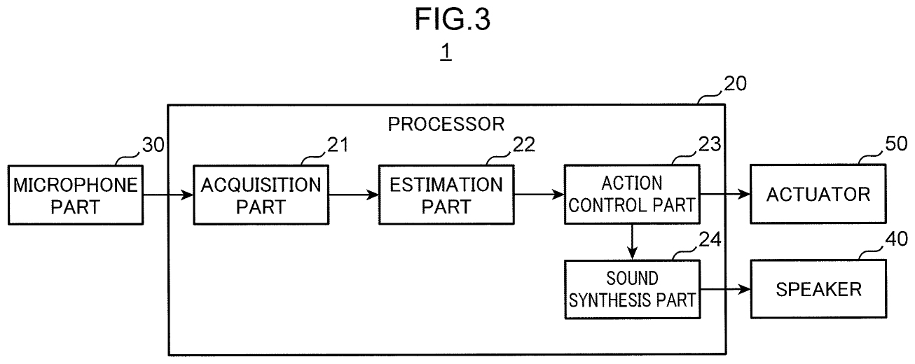

The main body 10 includes a bottom surface 10a. The bottom surface 10a has a ring shape in a top view, and includes a protrusion 10b protruding downward. The base 13 has an upper surface formed with a groove having a ring shape and into which the protrusion 10b is fitted. The main body 10 includes a housing 10c having a dome shape. The housing 10c accommodates a microphone part 30, a speaker 40, a processor 20, an actuator 50, and the like shown in FIG. 3. The main body 10 is guided by a drive power from the actuator 50 into the groove formed on the base 13 to rotate in the yaw direction. The rotation of the main body 10 relative to the base 13 allows the microphone part 30, the speaker 40, the processor 20, and the actuator 50 accommodated in the main body 10 to go round integrally with the main body 10. The base 13 having a round shape in the top view is placed on the ground. Thus, the dialogue robot 1 is installed on the ground.

The cameras 11, 12 are arranged at positions corresponding to eyes of the dialogue robot 1. Specifically, the cameras 11, 12 are arranged symmetrically with respect to a line passing a frontal center position 2. The cameras 11, 12 include image sensors each taking an image of surroundings.

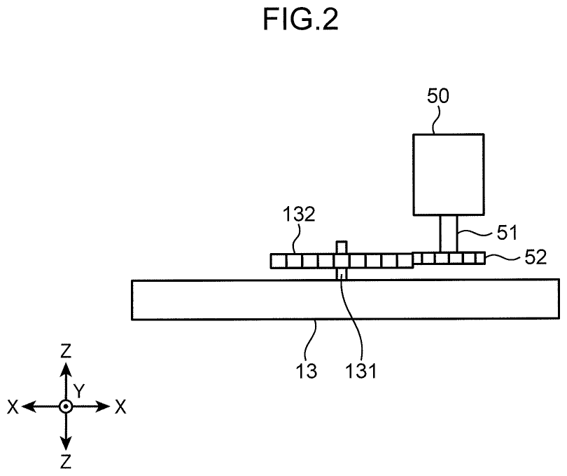

FIG. 2 is a diagram showing an exemplary rotating mechanism of the dialogue robot 1. The base 13 has a center attached with a gear shaft 131 standing upwardly. The gear shaft 131 has an upper end attached with a first gear 132. The actuator 50 has a gear shaft 51 extending downwardly from a bottom surface thereof. The gear shaft 51 has a lower end attached with a second gear 52. The first gear 132 and the second gear 52 mesh with each other. When the actuator 50 is driven, the driving power rotates the first gear 132 via the second gear 52. Consequently, the main body 10 rotates relative to the base 13 about the Z axis.

FIG. 3 is a block diagram showing an exemplary configuration of the dialogue robot 1. The dialogue robot 1 includes the processor 20, the microphone part 30, the speaker 40, and the actuator 50. The processor 20 is constituted by a Central Processing Unit (CPU). The processor 20 includes an acquisition part 21, an estimation part 22, an action control part 23, and a sound synthesis part 24. The processor 20 executes a program to let the acquisition part 21 to the sound synthesis part 24 each to work. However, this is merely an example. The acquisition part 21 to the sound synthesis part 24 each may be constituted by a dedicated hardware circuit.

The acquisition part 21 acquires a voice signal representing a voice of the user collected by the microphone part 30. The voice signal acquired by the acquisition part 21 includes a plurality of individual voice signals of a plurality of microphones constituting the microphone part 30. The acquisition part 21 sets the dialogue robot 1 to a stand-by state for a voice when detecting no voice. In the stand-by state, the acquisition part 21 sets the directivity direction of the microphone part 30 to omnidirectional, i.e., to 360 degrees. This enables the microphone part 30 to collect a voice of a user staying at any position relative to the dialogue robot 1. On the other hand, the acquisition part 21 sets the directivity direction of the microphone part 30 to a reference direction of the microphone part 30 when acquiring a voice signal of the user. The reference direction of the microphone part 30 is set to a forward direction of the dialogue robot 1. The directivity direction of the microphone part 30 thus aligns with the forward direction of the dialogue robot 1. The acquisition part 21 may use a beamforming technique to set the directivity direction of the microphone part 30 to the forward direction.

The estimation part 22 estimates a direction toward the user who produced the voice, i.e., the direction toward the sound source on the basis of the voice signal acquired by the acquisition part 21. Specifically, the estimation part 22 detects a time difference (phase difference) between the plurality of individual voice signals of the plurality of microphones constituting the microphone part 30, and estimates a direction toward the user using the detected phase difference. For example, in a configuration where the microphone part 30 includes a first microphone and a second microphone, assuming that a pitch between the first microphone and the second microphone is d, a speed of sound is c, a time difference is τ, and an angle between a reference direction of the microphone part 30 and a direction of the user is θ, the angle θ is expressed by the following Equation (1).

$$θ = {sin}^{- 1} ( c \times τ / d ) \qquad ( 1 )$$

The action control part 23 outputs to the actuator 50 an action signal to cause the dialogue robot 1 to align the directivity direction of the microphone part 30 with the estimated direction toward the user. The dialogue robot 1 thus performs the response action.

The response action is an action of aligning the forward direction of the dialogue robot 1 with a direction toward the user. In the description hereinafter, the response action includes an action of rotating the main body 10 to align the forward direction of the dialogue robot 1 with the direction toward the user. The alignment is not limited to an exact agreement but may involve some discrepancies. A permissible range of discrepancy includes, for example, ±1 to 5 degrees.

The action control part 23 outputs to the sound synthesis part 24 an instruction signal to cause the speaker 40 to continuously output a response sound to the user while the dialogue robot 1 performs the response action. The response sound includes a sound that responds to the voice of the user. An example of the response sound includes an utterance of “Yes”. However, this is merely an example. It may be appreciated to adopt a desirable utterance such as “OK” as the response sound. Further, it may be appreciated to adopt a sound different from a voice, such as a beep sound or a melodious sound as the response sound.

The sound synthesis part 24 performs a sound synthesis process in accordance with the instruction signal outputted by the action control part 23 to thereby generate a sound signal representing a response sound, and outputs to the speaker 40 the sound signal representing the generated response sound. Accordingly, the response sound is output from the speaker 40.

The microphone part 30 includes the plurality of microphones, collects a voice, and outputs to the acquisition part 21 a voice signal representing the collected voice.

The speaker 40 converts a sound signal into a sound.

For example, the actuator 50 includes an electric motor. The actuator 50 acquires the action signal outputted from the action control part 23, and rotates the second gear 52 in accordance with the acquired action signal. The dialogue robot 1 is thus rotated relative to the base 13.

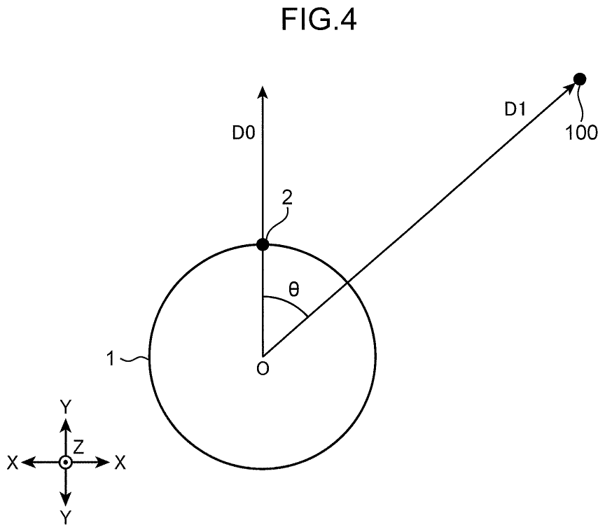

FIG. 4 is a diagram showing a positional relationship between the dialogue robot 1 and a user 100. FIG. 4 shows the dialogue robot 1 and the user 100 viewed from above. As shown in FIG. 4, the dialogue robot 1 has a round shape when viewed from above. D0 denotes the forward direction of the dialogue robot 1. D1 denotes a direction toward the user 100 (hereinafter referred to as “a user direction”). The forward direction D0 extends through the frontal center position 2 from a center O of the dialogue robot 1.

Since the center O and the frontal center position 2 are at the same height, the forward direction D0 is parallel to a surface on which the dialogue robot 1 is placed. The angle θ is an angle between the forward direction D0 and the user direction D1. In other words, the angle θ is an angle of a location of the user 100 in the yaw direction with reference to the forward direction D0. In this embodiment, the angle θ is a value from zero to 180 degrees and positive in a clockwise direction and negative in a counterclockwise direction, for example.

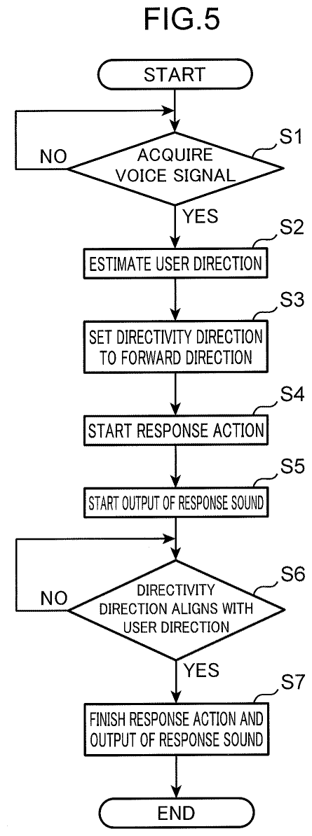

FIG. 5 is a flowchart showing an exemplary process of the dialogue robot 1 according to Embodiment 1. Before a start of this flowchart, the acquisition part 21 sets the directivity direction of the microphone part 30 at 360 degrees, wherein the dialogue robot 1 is in the stand-by state.

In Step S1, the acquisition part 21 determines whether or not a voice signal is acquired. When the acquisition part 21 acquires a voice signal having a sound pressure of a certain level or higher, determination in Step S1 is YES, when the sound pressure has a level lower than the certain level, determination in Step S1 is NO. For example, when an average sound pressure of the respective individual voice signals acquired from the microphones has the certain level or higher, it is determined that the acquisition part 21 acquires a voice signal. The certain level is, for example, a sound pressure level allowing to judge that a person utters. In a case of presence of a plurality of sound sources attributed to utterances of a plurality of users, the acquisition part 21 determines as the user direction D1 a direction toward a sound source with the highest sound pressure level. In the case of YES in Step S1, the process proceeds to Step S2 In the case of NO in Step S1, the process waits in Step S1.

Further, in Step S2, the estimation part 22 estimates the user direction D1 on the basis the voice signal acquired by the acquisition part 21. For example, the estimation part 22 calculates an angle θ by assigning the voice signal acquired by the acquisition part 21 in Equation (1), thereby estimating the calculated angle θ as the user direction D1.

Further, in Step S3, the action control part 23 sets the directivity direction of the microphone part 30 to the forward direction D0 by beamforming.

Further, in Step S4, the action control part 23 outputs to the actuator 50 an action signal of rotating the main body 10 to align the forward direction D0 with the user direction D1 to thereby start a response action. The dialogue robot 1 thus starts a rotating action of aligning the forward direction D0 of the main body 10 with the user direction D1.

Further, in Step S5, the action control part 23 outputs to the sound synthesis part 24 an instruction signal of letting outputting a response sound so that the speaker 40 starts an output of the response sound.

Further, in Step S6, the action control part 23 determines whether the directivity direction of the microphone part 30 aligns with the user direction D1. Specifically, the action control part 23 aligns the forward direction D0 with the user direction D1 so that the directivity direction of the microphone part 30 aligns with the user direction D1.

The action control part 23 may be configured to output to the actuator 50 an action signal of rotating the main body 10 by an angle θ so that the main body 10 rotates by the angle θ. In this configuration, the action control part 23 determines whether the current supply to the actuator 50 is finished or not by using a current sensor. When the current supply is determined to be finished, it is determined that the directivity direction of the microphone part 30 aligns with the user direction D1. Alternatively, the action control part 23 may be configured to determine whether a rotation angle of the main body 10 reaches the angle θ by using an angle sensor. When t he rotation angle of the main body 10 reaches the angle θ, it is determined that the directivity direction of the microphone part 30 aligns with the user direction D1.

When the directivity direction of the microphone part 30 aligns with the user direction D1 (YES in Step S6), the process proceeds to Step S7. When the directivity direction of the microphone part 30 does not align with the user direction D1 (NO in Step S6), the process waits in Step S6.

Further, in Step S7, the action control part 23 finishes the response action and the output of the response sound. For example, in the configuration where the current sensor is used, the action control part 23 finishes the output of the response sound by outputting to the sound synthesis part 24 an instruction signal of finishing the output of the response sound. In the configuration where the angle sensor is used, the action control part 23 outputs to the actuator 50 an action signal of finishing the response action in addition to the instruction signal of finishing the output of the response sound.

The dialogue robot 1 according to Embodiment 1 thus continuously outputs the response sound to the user 100 from the speaker while performing the response action of aligning the directivity direction of the microphone part 30 with the user direction D1. This can keep the user 100 from uttering during the response action and thus prevent misrecognition of the voice during the response action.

### Embodiment 2

A dialogue robot 1 according to Embodiment 2 is characterized by calculating a response duration and performing a response action using the response duration. In Embodiment 2, the same constituent elements as those of Embodiment 1 are allotted with the same reference numerals. The description of the same elements is omitted. Further, the block diagram of Embodiment 2 is identical to that in FIG. 3.

With reference to FIG. 3, an action control part 23 determines a response duration indicative of a duration of a response action on the basis of an angle θ calculated by an estimation part 22, and causes a speaker 40 to continuously output a response sound during the response duration. For example, the action control part 23 calculates the response duration by dividing the angle θ by a predetermined rotational speed. The predetermined rotational speed is a rotation angle per unit time, i.e., an angular speed, in a rotating action of a main body 10. The rotational speed is stored in advance in an unillustrated memory. The rotational speed is an example of an action speed.

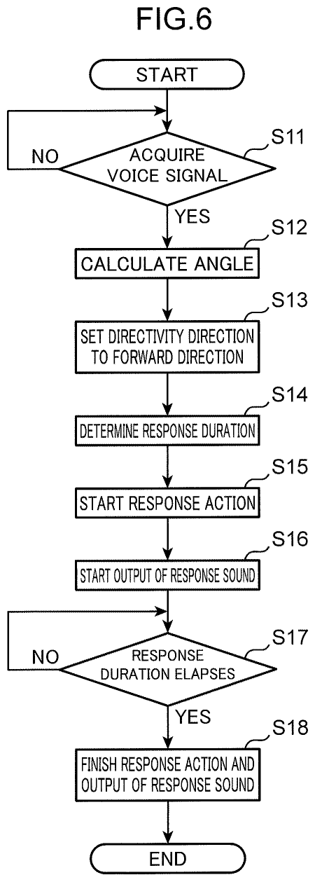

FIG. 6 is a flowchart showing an exemplary process of the dialogue robot 1 according to Embodiment 2. The processing in Step S11 is identical to that in Step S1 in FIG. 5. In Step S12, the estimation part 22 calculates an angle θ between a forward direction D0 and a user direction D1 on the basis of a voice signal acquired by an acquisition part 21. The estimation part 22 may calculate the angle θ using the above Equation (1). The processing in Step 13 is identical to that in Step S3.

Further, in Step S14, the action control part 23 determines the response duration by dividing the angle θ calculated in Step S12 by the rotational speed.

Further, in Step S15, the action control part 23 outputs to an actuator 50 an action signal of rotating the main body 10. The dialogue robot 1 thus starts a rotating action of aligning the forward direction D0 of the main body 10 with the user direction D1. For rotating the main body 10 clockwise, the action control part 23 may output to the actuator 50 an action signal of rotating the actuator 50 clockwise. On the other hand, for rotating the main body 10 counter-clockwise, the action control part 23 may output to the actuator 50 an action signal of rotating the actuator 50 counter-clockwise.

The processing in Step 16 is identical to that in Step S5 in FIG. 5.

Further, in Step S17, the action control part 23 determines whether the response duration elapses or not. For example, the action control part 23 may measure an elapsed time from a start of the response action by using a timer and determine whether the response duration elapses or not on the basis of the measured elapsed time.

When the response duration elapses (YES in Step S17), the process proceeds to Step S18, and when the response duration still does not elapse (NO in Step S17), the process waits in Step S17. The processing in Step 18 is identical to that in Step S7 in FIG. 5.

The dialogue robot 1 according to Embodiment 2 thus determines the response duration on the basis of the angle θ between the directivity direction of the microphone part 30 and the user direction D1. Therefore, an end time of an output of a response sound can be determined without monitoring the response action to detect the end time of the output of the response sound.

### Embodiment 3

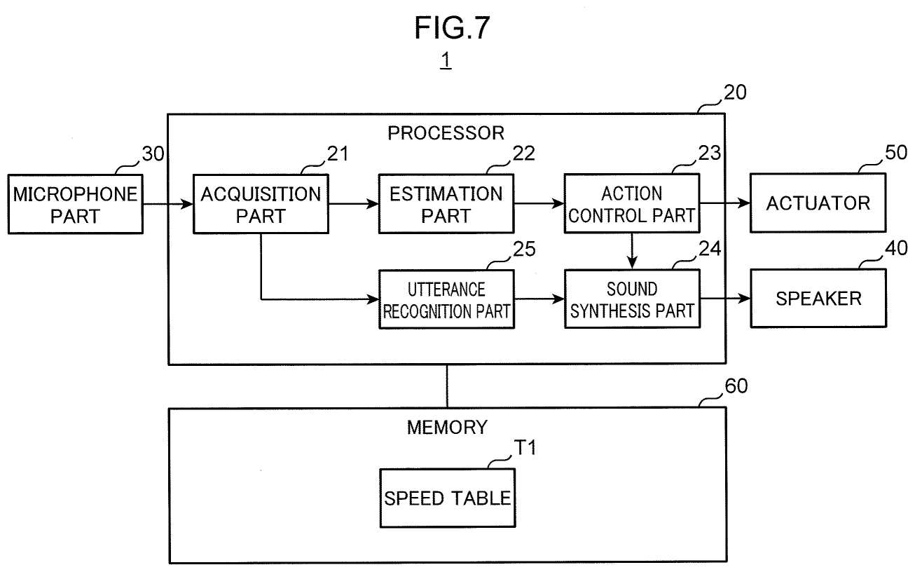

Embodiment 3 is characterized by calculating a response duration using a rotational speed acquired from a speed table. In Embodiment 3, the same constituent elements as those of Embodiments 1 and 2 are allotted with the same reference numerals. The description of the same elements is omitted. FIG. 7 is a block diagram showing an exemplary configuration of a dialogue robot 1 according to Embodiment 3.

In Embodiment 3, the dialogue robot 1 further includes a memory 60. The memory 60 includes a rewritable non-volatile storage device, e.g., flash memory. A processor 20 further includes an utterance recognition part 25.

The utterance recognition part 25 applies a speech recognition process to a voice signal acquired by an acquisition part 21 to thereby recognize an utterance content of a voice produced by the user 100.

The memory 60 stores a speed table T1. The speed table T1 stores a plurality of rotational speeds that can be set for a rotating action of a main body 10. Specifically, the speed table T1 stores the plurality of rotational speeds corresponding to utterance contents recognized by the utterance recognition part 25. For example, when the utterance content of the user 100 is “Good morning”, the speed table T1 stores a rotational speed corresponding to “Good morning”. When the utterance content of the user 100 is the name of the dialogue robot 1, the speed table T1 stores a rotational speed corresponding to the name.

The action control part 23 acquires a rotational speed corresponding to an utterance content recognized by the utterance recognition part 25 from the speed table T1 and sets a rotational speed of an actuator 50 such that the main body 10 rotates at the acquired rotational speed.

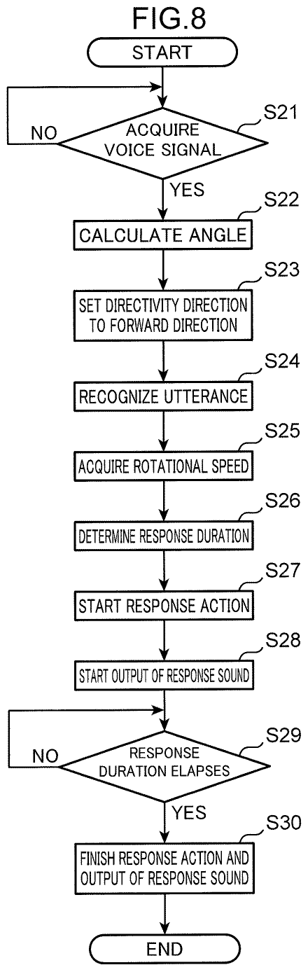

FIG. 8 is a flowchart showing an exemplary process of the dialogue robot 1 according to Embodiment 3. The processings in Steps S21 to S23 are identical to those in Steps S11 to S13 in FIG. 6.

Further, in Step S24, the utterance recognition part 25 applies the speech recognition process to the voice signal acquired by the acquisition part 21 to thereby recognize the utterance content of the user 100. In a case of utterances of a plurality of users, a voice signal from a direction of a sound source with the highest sound pressure may be used to recognize an utterance content of a user 100.

Further, in Step S25, the action control part 23 acquires from the speed table T1 a rotational speed corresponding to the voice recognized by the utterance recognition part 25. In a case where no rotational speed corresponding to the voice recognized by the utterance recognition part 25 is stored in the speed table T1, the action control part 23 may acquire a default rotational speed from the speed table T1.

Further, in Step S26, the action control part 23 determines a response duration by dividing an angle θ calculated in Step S22 by the rotational speed acquired in Step S25.

Further, in Step S27, the action control part 23 outputs an action signal to the actuator 50 as in Step S15. The action control part 23 sets a rotational speed of the actuator 50 to the rotational speed acquired in Step S25.

The processings in Steps S28 to S30 are identical to those in Steps S16 to S18 in FIG. 6.

In this way, the dialogue robot 1 according to Embodiment 3 calculates a response duration by taking into account a rotational speed corresponding to an utterance content. Therefore, an end time of an output of a response sound can be made to exactly coincide with an end time of a response action.

### Embodiment 4

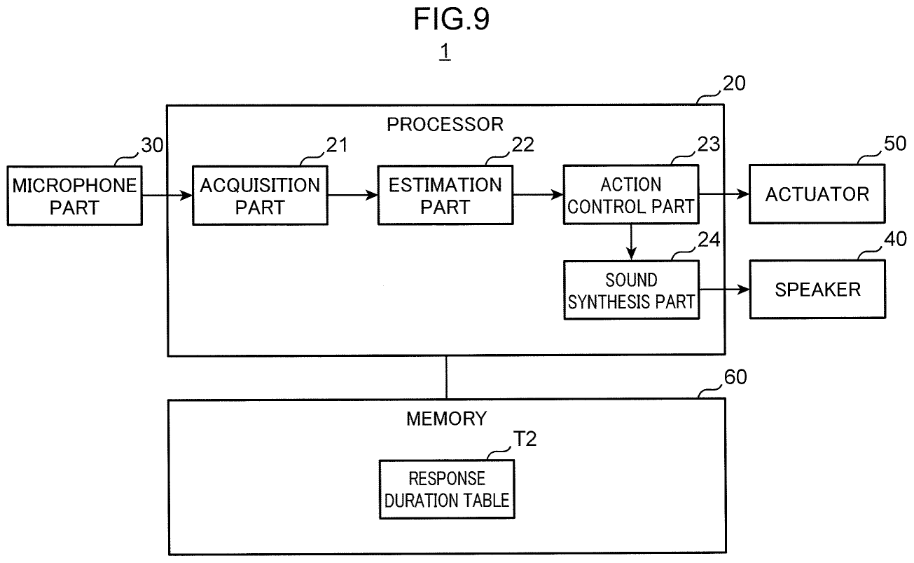

A dialogue robot 1 according to Embodiment 4 is characterized by determining a response duration by referring to a response duration table. FIG. 9 is a block diagram showing an exemplary configuration of the dialogue robot 1 according to Embodiment 4.

In Embodiment 4, a memory 60 of the dialogue robot 1 stores a response duration table T2. The response duration table T2 stores an angle θ between a directivity direction of a microphone part 30 and a user direction D1 and a response duration indicative of a duration of a response action corresponding to the angle θ. The response duration table T2 is exemplary response duration information.

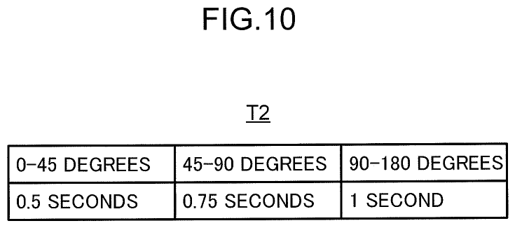

FIG. 10 shows an exemplary data structure of the response duration table T2. The response duration table T2 stores a response duration of 0.5 seconds when the angle θ is 0 degrees or more and less than 45 degrees, a response duration of 0.75 seconds when the angle θ is 45 degrees or more and less than 90 degrees, and a response duration of 1 second when the angle θ is 90 degrees or more and 180 degrees or less. The response duration table T2 stores an absolute value of an angle θ. Therefore, in the response duration table T2, an angle range of 0 degrees or more and 180 degrees or less is defined. In the response duration table T2, a relationship between the angle θ and the response duration is defined in a way that the response duration increases as the angle θ increases. Values of the response duration stored in the response duration table T2 are merely an example, and other values may be properly adopted. In FIG. 10, values of the response duration corresponding to the three angle ranges are defined. However, the number of angle ranges are not limited to three but may be either two or four or more.

Referring back to FIG. 9, an action control part 23 determines the response duration corresponding to the angle θ with reference to the response duration table T2.

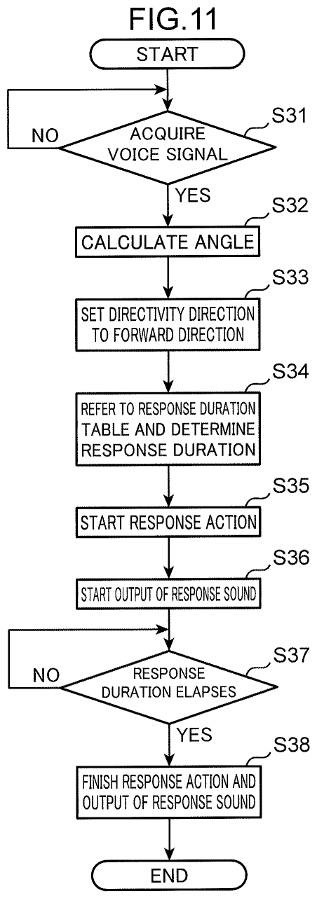

FIG. 11 is a flowchart showing an exemplary process of the dialogue robot 1 according to Embodiment 4. The processings in Steps S31 to S33 are identical to those in Steps S11 to S13 in FIG. 6.

In Step S34, the action control part 23 determines a response duration corresponding to the angle θ calculated in Step S32 with reference to the response duration table T2. The processes in Steps S35 to S38 are identical to those in Steps S15 to S18 in FIG. 6.

Since the dialogue robot 1 according to Embodiment 4 refers to the response duration table T2, the dialogue robot 1 can easily determine a response duration corresponding to an angle θ.

### Embodiment 5

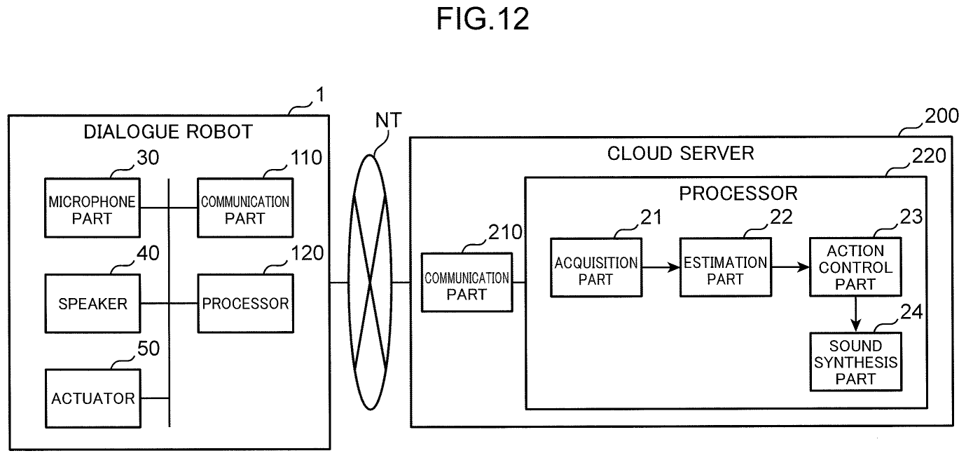

Embodiment 5 is characterized by controlling a dialogue robot 1 using a cloud server. FIG. 12 is a block diagram showing an exemplary configuration of a dialogue robot system according to Embodiment 5. The dialogue robot system includes the dialogue robot 1 and a cloud server 200. The dialogue robot 1 and the cloud server 200 are mutually communicably connected via a network NT.

The cloud server 200 includes a communication part 210 and a processor 220. The communication part 210 is constituted by a communication circuit that connects the cloud server 200 to the network NT. The communication part 210 sends to the dialogue robot 1 an action signal generated by an action control part 23 and a sound signal representing a response sound generated by a sound synthesis part 24. For example, the processor 220 is constituted by a central processing unit (CPU), and includes an acquisition part 21, an estimation part 22, an action control part 23, and a sound synthesis part 24.

The dialogue robot 1 includes a communication part 110 and a processor 120 in addition to the microphone part 30, the speaker 40, and the actuator 50 shown in FIG. 3. The communication part 110 is a communication circuit that connects the dialogue robot 1 to the network NT. The processor 120 controls the dialogue robot 1. The communication part 110 sends to the cloud server 200 a voice signal representing a voice collected by the microphone part 30.

The dialogue robot 1 according to Embodiment 5 can be controlled by the cloud server 200. The cloud server 200 may include each block of the processor 20 shown in Embodiments 2 to 4.

The present disclosure may adopt the following modifications.

Although the dialogue robots 1 in the above Embodiments are stationary robots, a mobile robot may be adopted. In this configuration, the dialogue robot 1 includes a pair or two or more pairs of wheels on a base 13. An actuator 50 moves the dialogue robot 1 in any direction by rotating the wheels. An action control part 23 moves the dialogue robot 1 by outputting to the actuator 50 an action signal to align a user direction D1 and a directivity direction of the microphone part 30 with each other. This causes the dialogue robot 1 to move so that the user direction D1 and the directivity direction of the microphone part 30 align with each other.

Further, in Step S1 in FIG. 5, when a voice signal has a sound pressure of a certain level or higher, the acquisition part 21 may be appreciated to determine on the basis of a feature of the voice signal whether the voice signal indicates an utterance of a person or not. When the voice signal is determined to indicate an utterance of a person, determination in Step 1 is YES, and when the voice signal is determined not to indicate an utterance of a person, determination in Step S1 is NO. This processing may be applied for Step S11, S21, and S31.

The present disclosure is useful in the field of pet robots which talk with users.

1. A dialogue robot, comprising:
a microphone part that includes a plurality of microphones;
an actuator that actuates the dialogue robot;
a speaker; and
a processor, wherein
the processor
acquires a voice signal indicative of a voice of a user collected by the microphone part,
estimates a direction toward the user on the basis of the voice signal,
outputs to the actuator an action signal of causing the dialogue robot to perform a response action of aligning a directivity direction of the microphone part with the estimated direction toward the user, and
causes the speaker to continuously output a response sound to the user while the response action is performed.

2. The dialogue robot according to claim 1, wherein
the processor
calculates an angle between the directivity direction of the microphone part and the direction toward the user on the basis of the voice signal,
determines a response duration indicative of a duration of the response action on the basis of the angle, and
causes the speaker to continuously output the response sound during the response duration.

3. The dialogue robot according to claim 1, wherein
the processor
acquires an action speed of the dialogue robot in the response action,
calculates a response duration indicative of a duration of the response action on the basis of the action speed, and
causes the speaker to continuously output the response sound during the response duration.

4. The dialogue robot according to claim 2, further comprising:
a memory that stores response duration information concerning the angle between the directivity direction and the direction toward the user and the response duration indicative of the duration of the response action corresponding to the angle, wherein
the processor refers to the response duration information and determines the response duration corresponding to the calculated angle.

5. The dialogue robot according to claim 1, wherein
the response action includes an action of rotating the dialogue robot to align the directivity direction of the microphone part with the estimated direction toward the user.

6. The dialogue robot according to claim 3, wherein
the action speed includes a rotational speed of the dialogue robot, and
the response duration is calculated by dividing the angle between the directivity direction of the microphone part and the estimated direction toward the user by the rotational speed.

7. The dialogue robot according to claim 1, wherein
the directivity direction includes a forward direction of the dialogue robot.

8. A control method for a dialogue robot by a computer, comprising:
acquiring a voice signal indicative of a voice of a user collected by a microphone part that is provided in the dialogue robot and includes a plurality of microphones,
estimating a direction toward the user on the basis of the voice signal,
outputting to an actuator of the dialogue robot an action signal of causing the dialogue robot to perform a response action of aligning a directivity direction of the microphone part with the estimated direction toward the user, and
causing a speaker of the dialogue robot to continuously output a response sound to the user while the response action is performed.

9. A non-transitory computer readable recording medium storing a program for causing a computer to execute a control method for a dialogue robot, the program causing the computer to:
acquire a voice signal indicative of a voice of a user collected by a microphone part that is provided in the dialogue robot and includes a plurality of microphones,
estimate a direction toward the user on the basis of the voice signal,
output to an actuator of the dialogue robot an action signal of causing the dialogue robot to perform a response action of aligning a directivity direction of the microphone part with the estimated direction toward the user, and
cause a speaker of the dialogue robot to continuously output a response sound to the user while the response action is performed.
